(19) United States
(12) Patent Application Publication
(10) Pub. No.: US 2025/0187220 A1
(43) Pub. Date: Jun. 12, 2025

(54) FOOD PORTIONING MACHINE AND METHODS OF OPERATION THEREOF

(71) Applicant: THURNE-MIDDLEBY LTD, Norwich Norfolk (GB)

(72) Inventors: James WAKEFIELD, Norwich Norfolk (GB); Alastair FEARNS, Norwich Norfolk (GB); Jacob WIGGETT, Norwich Norfolk (GB)

(21) Appl. No.: 18/843,049

(22) PCT Filed: Apr. 12, 2023
(86) PCT No.: PCT/GB2023/050978

§ 371 Date: Aug. 30, 2024

(30) Foreign Application Priority Data
Apr. 13, 2022 (GB) 2205487.8

(51) Int. Cl. B26D 5/28; B26D 1/26; B26D 7/01; B26D 7/06

(52) U.S. Cl. CPC B26D 5/28; B26D 1/26; B26D 7/01; B26D 7/0616; B26D 2210/02

(57) ABSTRACT

A food portioning machine (2) includes a portion thickness control assembly (22) comprising a carriage (40) carried by a machine base (4) and able to move relative to the machine base in order to adjust the thickness of each portion to be cut from a food product (90). A carriage drive assembly (46) is coupled to the carriage to move the carriage relative to the machine base, a product stop (50) is carried by the carriage and able to move relative to the carriage between advanced and retracted positions, and a product stop drive assembly (68) is coupled to the product stop to move the product stop between the advanced and retracted positions. The carriage drive assembly is operable to move the carriage to a position relative to the machine base with reference to the thickness (t) of the next portion to be cut, and the product stop drive assembly is operable to move the product stop from its retracted position to its advanced position for engagement by the leading end of the food product.

### FIELD OF THE DISCLOSURE

The present disclosure relates to a food portioning machine and method for operating such a machine to cut slices or portions from a food product. More particularly, it concerns control of the slice or portion thickness.

### BACKGROUND TO THE DISCLOSURE

It is known to feed food products such as bacon, cheese, fresh meat or cooked meat towards a cutting region in a food portioning machine using product drivers such as belt conveyors, tracks or rear end grippers. The food product, which may be in the form of an elongate loaf, log or block for example, is fed incrementally towards the cutting region, where slices or portions of a desired size are cut from a leading end of the food product.

In order to optimise their rate of throughput and to minimise the extent to which portions deviate from the desired weight, it is desirable for such machines to operate at high speed, whilst at the same time providing close control of the weight of the slices or portions outputted by the machine.

### SUMMARY OF THE DISCLOSURE

The present disclosure provides a food portioning machine comprising:
a machine base;
a feeder for feeding a food product in a feed direction;
a cutter for cutting portions from a leading end of a food product fed towards the cutter by the feeder; and
a portion thickness control assembly comprising:
   a carriage carried by the machine base and able to move relative to the machine base in order to adjust the thickness of each portion to be cut from the food product;
   a carriage drive assembly coupled to the carriage to move the carriage relative to the machine base;
   a product stop carried by the carriage and able to move relative to the carriage between advanced and retracted positions; and
   a product stop drive assembly coupled to the product stop to move the product stop between the advanced and retracted positions,
such that, before the cutter starts to cut a next portion from the leading end of the food product, the carriage drive assembly is operable to move the carriage to a position relative to the machine base with reference to the thickness of the next portion to be cut, and the product stop drive assembly is operable to move the product stop from its retracted position to its advanced position for engagement by the leading end of the food product.

In some existing portioning machines, the feeder is used to control the distance by which the food product is fed past the cutter before each cut is made, which in turn determines the thickness of the next portion to be cut. The use of a product stop according to the present disclosure may provide more accurate and repeatable control of the portion thickness. It may be more tolerant of variations in dimensions and/or physical properties between different food products in its governance of the product location at the start of the cut, and therefore more reliably provide accurate portion thickness control.

Preferably, the carriage is able to move linearly relative to the machine base. The carriage may be carried by the machine base such that this linear motion may be the only driven degree of freedom between the carriage and the machine base. This may enable the carriage location relative to the machine base to be controlled more precisely.

In preferred examples, the carriage is able to move relative to the machine base in a direction parallel to the feed direction in order to adjust the thickness of each portion to be cut from the food product.

The movable carriage together with the carriage drive assembly provides a versatile configuration which can be controlled to operate in different modes according to a user's requirements. The machine may be arranged to adjust the portion thickness from portion-to-portion, for example to provide a consistent portion weight notwithstanding variations in the cross-sectional area of the food product. Thus, the thickness of each portion may be determined individually. The machine may include a controller operable to determine the thickness of each slice with reference to data related to the external shape of the food product and its weight. The machine may be arranged to cut a group of portions from a food product that have the same thickness or weight and/or may be arranged to cut the whole food product into portions of equal thickness or weight.

The carriage may be directly mounted on a support which is attached to the machine base at a fixed location on the base.

The carriage may be movable relative to the machine base independently of the motion of the cutter.

The support may comprise one or a pair of parallel guide members to which the carriage is slidably coupled.

The advanced position may be at a predetermined location relative to the carriage which is unchanged during a portioning process. In that case, the thickness of the next slice or portion to be cut is solely dictated by the position of the carriage relative to the machine base.

Preferably, the carriage drive assembly comprises a linear actuator for moving the carriage relative to the machine base. This may provide accurate control of the carriage location over a relatively small distance, as needed to adjust the portion thickness (for example over a range of about 45 mm). Also, a linear actuator may be a relatively compact form of actuator for this purpose.

Once the cutter has started to cut a next portion from the food product, the product stop drive assembly is arranged to move the product stop from its advanced position towards its retracted position.

The acceleration and deceleration of the product stop during its transition from its retracted position to its advanced position and/or vice versa may be adjustable. The machine may include a controller operable to control the product stop drive assembly so as to adjust a velocity profile for a movement of the product stop. For example, the acceleration of the product stop as it moves away from the advanced position may be increased to ensure that any contact between a cut portion and the product stop is avoided as the portion falls away from the end of the remaining food product.

The distance travelled by the product stop from its advanced position to its retracted position may be adjustable. The controller may be operable to vary this distance in response to user input. For example, when cutting a product with a relatively small height dimension, the product stop may not need to be retracted as far to be moved clear of a falling cut portion, in comparison to the retraction distance required when cutting a relatively tall product. The ability to adjust this distance allows the time taken by the product stop to be retracted from and then returned to its advanced position to be minimised, thereby increasing the throughput achievable by the machine.

Preferably, the product stop drive assembly includes a rotary actuator and a mechanical coupling arranged to couple the rotary actuator to the product stop so that the rotary actuator is operable to move the product stop between the advanced and retracted positions. Alternatively, a linear actuator may be used to move the product stop between the advanced and retracted positions.

The rotary actuator may include an axis of rotation and a driven mount which is spaced from its axis of rotation, with the rotary actuator being operable to rotate the driven mount in an orbital motion around its axis of rotation, and the mechanical coupling being arranged to couple the driven mount of the rotary actuator to the product stop. The rotary actuator may be located in the machine with its axis of rotation perpendicular to the feed direction.

A rotary actuator coupled to the product stop to move the product stop between its advanced and retracted positions may readily provide a desirable velocity profile for the motion of the product stop. Orbital motion of a driven mount may facilitate smooth deceleration of the product stop as it approaches its advanced position, and smooth acceleration away from the advanced position. This allows the travel time to be reduced whilst still repeatably and reliably providing a suitable velocity profile. A mechanical linkage (including a rigid link arm, for example) may couple the driven mount to the product stop and translate the orbital motion of the driven mount into oscillation of the product stop between its advance and retracted positions.

The rotary actuator may be operated so as to rotate in the same direction to move the product stop between its advanced and retracted positions. This uses the maximum displacement or stroke of the product stop provided by the rotary actuator in combination with the coupling between the actuator and the product stop. Alternatively, the rotary actuator may be operated in another mode in which the actuator oscillates between two rotational positions to provide a reduced displacement or stroke for the product stop, with the retracted position being closer to the advanced position (relative to a retracted position reached by using the maximum displacement). This provides further versatility and control options for an operator of the machine.

In preferred implementations, the product stop is mechanically coupled to the carriage in such a way that, as the product stop moves between its retracted and advanced positions, its orientation in a vertical plane extending parallel to the feed direction is constant.

In some examples, the product stop may be mechanically coupled to the carriage in such a way that the height of the product stop, relative to the height of a plane defined by a top surface of a support for a food product as it is being sliced, is greater in the retracted position than in the advanced position.

The product stop may be mechanically coupled to the carriage by a pair of rigid arms, with a carriage end of each rigid arm being rotatably coupled to the carriage and a stop end of each rigid arm being rotatably coupled to the product stop, the carriage ends of the rigid arms are rotatable relative to the carriage about respective first and second pivotal axes, the stop ends of the rigid arms are rotatable relative to the product stop about respective third and fourth pivotal axes, the first to fourth pivotal axes are parallel to each other and perpendicular to the feed direction.

Provision of pivotable rigid arms to facilitate the motion of the product stop gives a reliable coupling arrangement between the product stop and the carriage over a suitable travel distance. The forces exerted by the product stop may be shared between the two rigid arms thereby reducing the load on each of the arms.

The arrangement of the rigid arms may provide a suitable trajectory for the product stop as it moves away from the advanced position, by causing the product stop to swing away with a component of its motion in the feed direction and also upwardly away from the cutting region of the machine. This may avoid contact between the product stop and a portion of the food product as it is cut from, and falls away from, the end of the food product.

In some preferred examples, the first and second pivotal axes are spaced apart along a direction which is non-parallel with the feed direction.

The rigid arms may be of equal length. In other embodiments, the lengths of the rigid arms may be different to alter the trajectory that the product stop moves through between its advanced and retracted positions.

Different lengths may be selected for the rigid arms and/or the spacings between the pivotal axes may be selected so that the angle of the product stop changes as it is retracted away from its advanced position and/or to alter the trajectory of the product stop as it is withdrawn. For example, the product stop may rotate in a plane perpendicular to the pivotal axes of the rigid arms as it is retracted away from its advanced position such that a lower region of a product engaging portion of the product stop is withdrawn more quickly from the cutting region than an upper region of the product engaging portion, to avoid contact with a portion being cut from the food product.

Preferably, the first and second pivotal axes are spaced apart by a greater distance than the third and fourth pivotal axes. This may cause the product stop to rotate in a plane perpendicular to the pivotal axes of the rigid arms as it is retracted away from its advanced position so as to more rapidly increase the height of the product stop above an underlying support surface.

In preferred implementations, the first pivotal axis is further downstream from the cutter than the second pivotal axis and the first pivotal axis is higher above the height of a plane defined by a top surface of a support for a food product as it is being sliced than the second pivotal axis.

The present disclosure further provides a method of operating a food portioning machine of any preceding claim, comprising the steps of:
a) moving the carriage relative to the support with the carriage drive assembly to adjust the thickness of a next portion to be cut from a food product;
b) moving the product stop to the advanced position with the product stop drive assembly; and
c) feeding the food product in the feed direction with the feeder until its leading end engages the product stop.

In preferred examples, the method includes the steps of:
d) after step c), starting to cut the next portion from the leading end of the food product; and
e) after step d), moving the product stop towards its retracted position with the product stop drive assembly before the next portion has been completely cut from the leading end of the food product.

### BRIEF DESCRIPTION OF THE DRAWINGS

Examples of the present disclosure will now be described with reference to the accompanying schematic drawings, wherein:

FIG. 1 is a side view of a food portioning machine according to an example of the present disclosure;

FIGS. 2 and 3 are side views of the portion thickness control assembly of the machine shown in FIG. 1;

FIGS. 4 to 7 are successive views of parts of the portion thickness control assembly of the machine shown in FIG. 1 as it moved between its retracted and advanced positions;

FIGS. 8 and 9 are front and rear perspective views of the portion thickness control assembly of the machine shown in FIG. 1 in its retracted position;

FIGS. 10 and 11 are front and rear perspective views of the portion thickness control assembly of the machine shown in FIG. 1 in its retracted position; and

FIGS. 12 and 13 are side views of the portion thickness control assembly of the machine shown in FIG. 1 in advanced and partially retracted positions, respectively.

### DETAILED DESCRIPTION

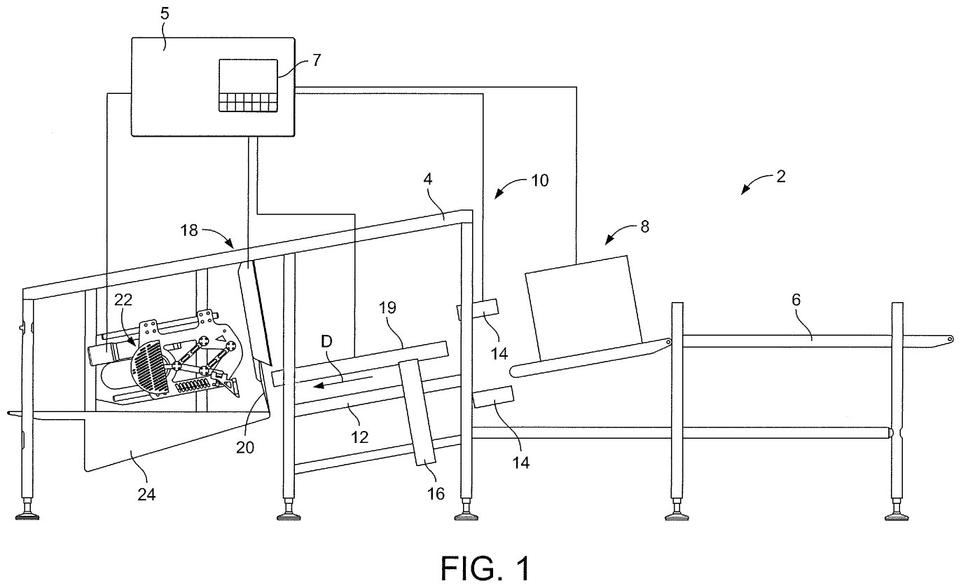

FIG. 1 shows a food portioning machine 2 having a machine base in the form of a rigid base framework 4. The operation of the machine is governed by an electronic control system 5 which is communicatively coupled to components of the machine. The control system includes a user interface 7 to enable an operator to input control parameters and commands.

Food products to be processed by the machine are loaded consecutively onto a horizontal pre-feed conveyor 6. The food products are then passed by the pre-feed conveyor to an intermediate station 8. The path of the food products through the intermediate station 8 is inclined downwardly in a direction away from the pre-feed conveyor.

The intermediate station 8 is arranged to carry out one or more preparatory processes on each food product. The process(es) may be one or more processes selected from imaging and weighing processes, for example.

The food products are then moved from the intermediate station 8 onto a feed conveyor 12. A scanning region 10 is located between the intermediate station 8 and the feed conveyor 12. The scanning region includes two or more scanning devices 14 which are configured to detect the transverse cross-sectional shape of the food product as it passes through the region. For example, each scanning device may include a light source for projecting a line of light across the product which is detectable by a camera of the scanning device.

An end gripper 16 is provided for engaging a trailing end of a food product carried by the feed conveyor 12. The end gripper and feed conveyor cooperate to form a feeder for feeding each food product in a feed direction “D” towards a cutter 18. As the food product is fed towards the cutter by the feeder, it is constrained vertically by a top support 19, which exerts a downward force on the upper surface of the food product.

The cutter includes a blade 20. The blade 20 may be in the form of an orbitally-mounted circular blade, an involute blade or a sickle-shaped knife blade, for example.

A portion thickness control assembly 22 is provided downstream of the cutter 18.

A jump conveyor and stacker assembly 24 is located below the portion thickness control assembly. Slices or portions cut from a food product by the cutter fall onto the assembly 24 which is operable to arrange consecutive slices or portions in a desired configuration, such as groups, or vertical or shingled stacks, for example. The assembly 24 conveys the slices or portions towards a packaging station (not shown).

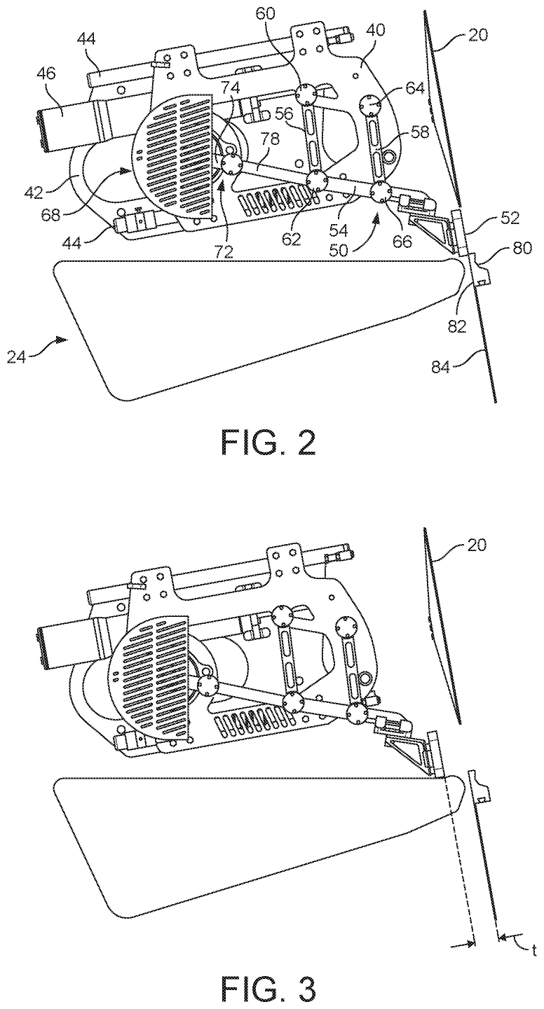

The portion thickness control assembly 22 will now be described in more detail with reference to FIGS. 2 to 11. The assembly comprises a carriage 40 carried by a support 42 and the support is mounted in a fixed position relative to the machine base. The support includes a pair of parallel guide members in the form of rails 44. The carriage is able to slide along the rails. A carriage drive assembly 46 is coupled to the carriage and operable to move the carriage along the rails. The carriage drive assembly may be in the form of a linear actuator which may be pneumatically, hydraulically or electromagnetically operated. It will be appreciated that other mechanisms may be used to provide the carriage drive assembly for moving the carriage relative to its support 42. For example, the carriage may be coupled to a drive belt which is driven by an electric motor.

A product stop 50 is carried by the carriage 40. The product stop includes a product contact paddle 52 which is rigidly coupled to a support arm 54. The support arm is coupled to the carriage via a first and second rigid arms 56, 58. The first and second rigid arms are pivotably coupled to the carriage and support arm. The first rigid arm is coupled to the carriage by a first pivot 60 at one end and to the support arm by third pivot 62 at its other end. The second rigid arm is coupled to the carriage by a second pivot 64 at one end and to the support arm by fourth pivot 66 at its other end.

In the example shown in the drawings, the distance between the first and third pivots 60,62 is the same as the distance between the second and fourth pivots 64,66. Also, the distance between the first and second pivots 60,64 is the same as the distance between the third and fourth pivots 62,66.

The spacings of the pivots may be varied in order to adjust the trajectory followed by the product stop as it is advanced and withdrawn. For example, the distance between the first and second pivots 60,64 may be greater than the distance between the third and fourth pivots 62,66, whilst the distance between the first and third pivots 60,62 is substantially the same as the distance between the second and fourth pivots 64,66. This arrangement may cause the product stop to be raised more rapidly as it is withdrawn.

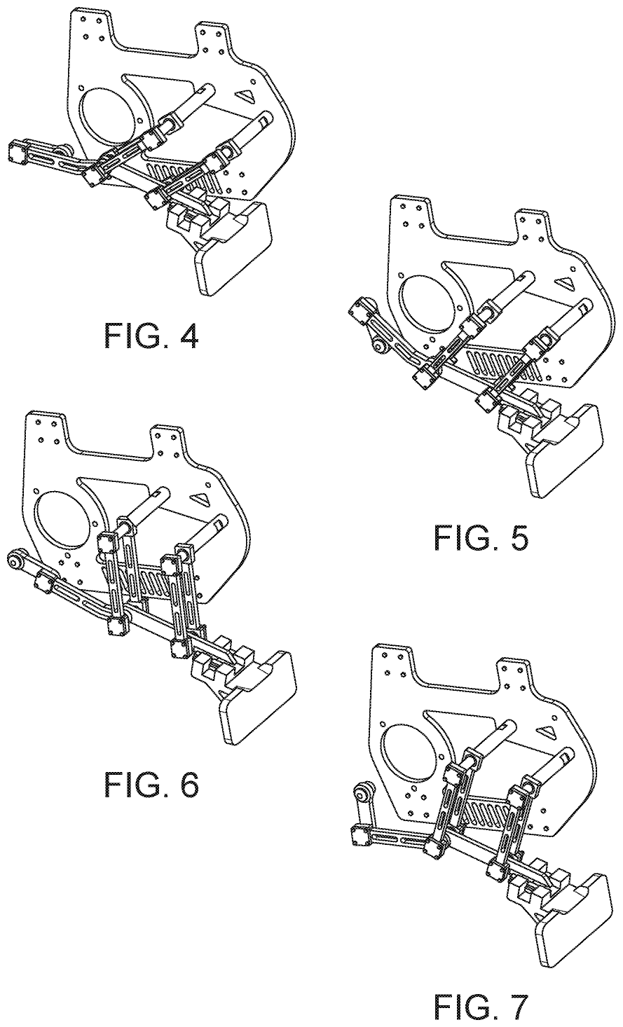

As can be seen in FIGS. 4 to 11, the rigid arms 56 and 58 may each comprise a pair of rigid limbs coupled to opposite sides of the support arm to resist rotation of the support arm about its length.

A product stop drive assembly 68 is mounted on the carriage. It comprises a rotary actuator 70 and a mechanical coupling 72 for coupling the rotary actuator to the support arm 54 of the product stop 50. A drive arm 74 is mounted at one end on a drive shaft 76 of the rotary actuator. The other end of the drive arm is pivotably coupled to one end of a link arm 78. The other end of the link arm 78 is pivotably coupled to one end of the support arm 54.

The mechanical coupling 72 is arranged such that rotation of the drive arm by the rotary actuator causes the link arm 78 to exert pushing or pulling forces on the support arm 54 causing it to move relative to the carriage as the rigid arms swing around their respective pivots 60 and 64. The product stop drive assembly is thereby able to move the product stop between advanced and retracted positions, with the advanced position being further from the rotary actuator than the retracted position.

The distance between the advanced and retracted positions may be altered by changing the length of the drive arm 74 and/or the link arm 78. Alternatively, or additionally, this distance may be adjusted by controlling the rotary actuator to change the distance or stroke over which the product stop is retracted from its advanced position.

The product stop is shown in its advanced position in FIGS. 2 and 3. The location of the advanced position relative to the blade 20 is adjusted by moving the carriage relative to its support 42 by means of the carriage drive assembly 46.

The food portioning machine includes a shear edge 80 having a downstream face 82 which lies in a cutting plane 84. The blade 20 is operable to cut a slice or portion from a leading end of a food product which extends over the shear edge and through the cutting plane. In operation of the machine, the advanced position of the product stop determines the extent to which the food product extends beyond the cutting plane and therefore the thickness of the next slice or portion to be cut from the food product.

The retracted position is further from the cutting plane in the feed direction than the advanced position. Preferably, the retracted position is also higher relative to the machine base than the advanced position.

In the configuration shown in FIG. 2, the product contact paddle 52 is held close to the cutting plane for cutting a relatively thin slice or portion. In contrast, in FIG. 3, the product contact paddle is held further away from the cutting plane, where it is spaced from the cutting plane by a distance “t” for cutting a slice or portion having a thickness equal to distance “t”.

In preferred implementations, the product drive assembly is arranged such that when the product support is in its advanced position, a force generated by a food product being pushed (by the end gripper 16) against the food support is exerted on the rotary actuator along a line which coincides with the rotational axis 71 of the rotary actuator. This avoids exertion of a torque on the rotary actuator by the product support. Accordingly, the force which the food support is able to withstand is increased, which thereby reduces the likelihood of any movement of the food support in response to contact between the food support and the food product. In turn, this leads to accurate slice or portion thickness control.

When the product support is in its advanced position, longitudinal axes of the support arm 54, link arm 78 and drive arm 74 are preferably in alignment with each other and with the rotational axis of the rotary actuator, such that a force generated by a food product pushing against the food support is exerted on the rotary actuator along a line which coincides with its rotational axis 71. The product support is shown in its advanced position in FIGS. 2, 3 and 6, for example.

The support arm 54 is preferably held at an angle relative to the upper surface of the conveyor 24, such that the end closer to the cutting region is closer to the conveyor 24 than the end further from the cutting region. This ensures that sufficient space is available at a location spaced from the conveyor for provision of the rotary actuator adjacent to the end of support arm 54 that is further from the cutting region.

FIGS. 4 to 7 show successive configurations of the drive arm 74, link arm 78 and product stop 50 as the drive arm is rotated clockwise (as viewed in the Figures) by the rotary actuator 70. Other components of the product thickness control assembly are omitted from these Figures for clarity. The product stop is shown in its retracted position in FIG. 4 and its advanced position in FIG. 6.

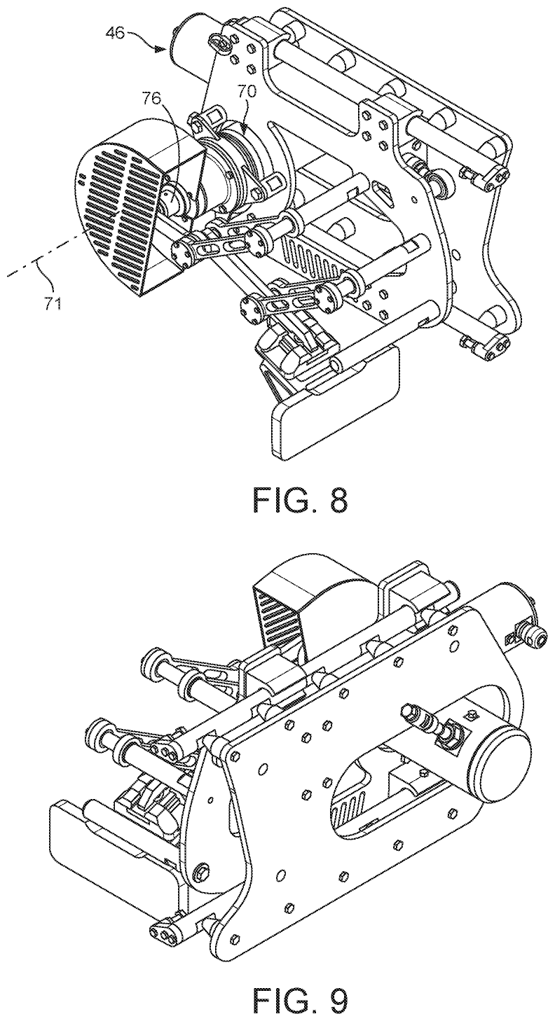

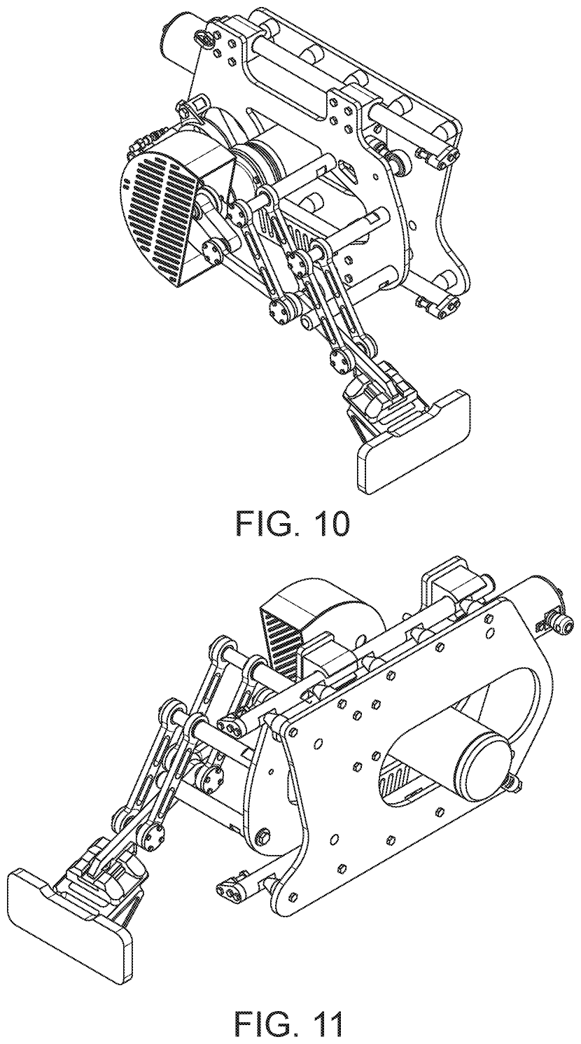

The product thickness control assembly is shown in FIGS. 8 and 9 with its product stop in its retracted position and in FIGS. 10 and 11 with the product stop in its advanced position.

In some embodiments, the relative position of the carriage 40 with respect to the line of action of the cutting may be adjusted, by moving the carriage (as discussed herein) in order to alter the thickness of the cut. In some embodiments, the position of the carriage 40 may be moved as appropriate up to every cut cycle. As would be readily understood by one of ordinary skill in the art, the thickness of the cut may be altered for one or more reasons, such as varying cross-section of the portion of the food to be cut, or the preparation of different thicknesses of cut within a single package based upon potential customer preference. Information that the control system 5 of the machine receives regarding the volume of the food to be cut (for example from the scanning devices 14 positioned upstream of the cutter) may be used to determine that the carriage 40 needs to be moved with respect to the cutting plane before the next cut.

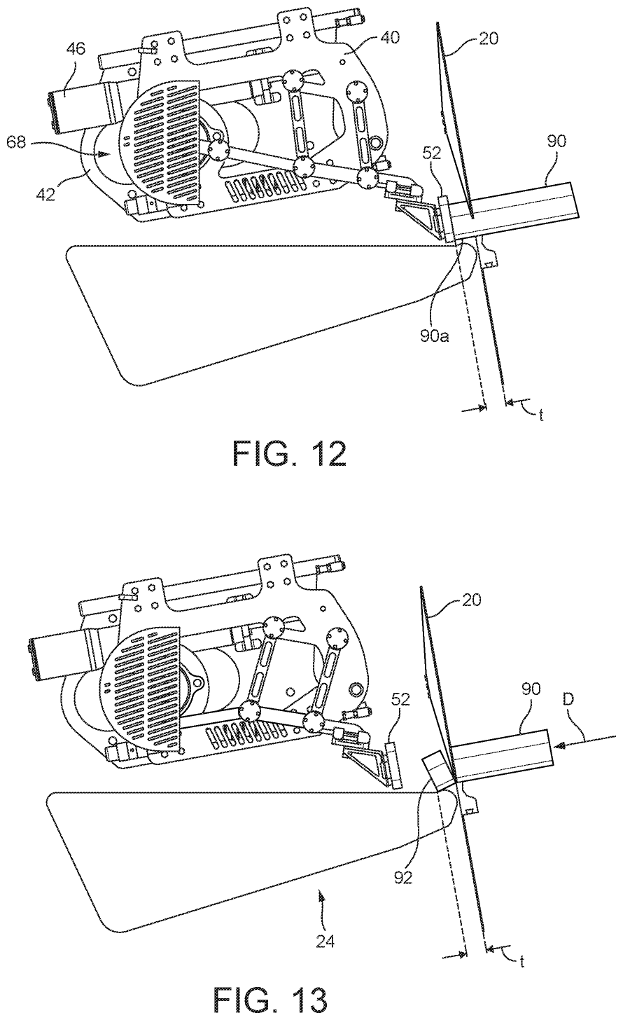

Cutting of a food product by the food portioning machine will now be described with reference to FIGS. 12 and 13. The carriage 40 is positioned relative to its support 42 by the carriage drive assembly 46 having regard to the thickness “t” of the next slice to be cut. After completion of a preceding cut, the product stop is moved to its advanced position (shown in FIG. 12) by the product stop drive assembly 68. A food product is urged through the cutting plane 82 by the feeder of the machine (not shown in FIGS. 12 and 13) to bring its leading end 90a into contact with the product contact paddle 52.

The magnitude of the force exerted on the food product by the feeder may be controllable. It may be controlled to urge the food product into contact with force for reliable cutting without deforming the food product to an unacceptable extent or changing the location of the product contact paddle.

In FIG. 12, the blade is shown a short time after it has started to cut the next slice or portion from the food product 90. In this example, the blade is an orbitally mounted circular blade, and its orbital motion has caused the blade to move downwardly into the product. At this stage, the product stop drive assembly is operated to begin withdrawal of the product stop from its advanced position towards its retracted position. This is to minimise any resistance to the cutting action due to pressure exerted on the leading end of the food product by the product stop, allowing the thickness of the blade to penetrate reliably into the food product. The product stop is held in its advanced position for a period of time after cutting has started to ensure accurate engagement of the edge of the blade with the food product during the initial part of the cutting action and thereby optimise the accuracy of the thickness control.

The product stop is then retracted in such a way that a cut slice or portion falling away from the food product is unimpeded by the product stop. FIG. 13 shows a stage following that of FIG. 12, in which the blade has separated a portion 92 from the leading end 90a of the product. The portion then falls away from the food product due to the feed direction “D” (and therefore the plane of the portion) being inclined at an angle to horizontal. In FIG. 13, the portion 92 is shown as it falls towards the jump conveyor and stacker assembly 24. By this point, the product contact paddle 52 has been retracted sufficiently far away from the blade by the product stop drive assembly along the direction of product flow through the machine to avoid any contact of the paddle with the falling portion.

The operations of different components of the machine are governed and co-ordinated by its control system 5. In particular, the control system ensures the action of the portion thickness control assembly is synchronised as discussed above with the cutting action of the blade. A drive of the blade may include a position encoder which generates signals indicative of the current position of the blade in its cutting cycle.

These signals are fed to the control system. The rotary actuator 70 of the product stop drive assembly may also include a position encoder which generates signals indicative of the current position of the product stop. These signals are also fed to the control system, which is then able to produce control signals which are sent to the rotary actuator to control its timing and motion profile in synchronism with the motion of the blade.

It will be appreciated that references herein to perpendicular or parallel relative orientations are to be interpreted as defining perpendicular or parallel relationships between components within practical tolerances. The term “substantially” may be used to indicate within 10% or more preferably within 5%.

The following enumerated paragraphs represent illustrative, non-exclusive ways of describing examples according to the present disclosure.

A. A food portioning machine comprising:
a machine base;
a feeder for feeding a food product in a feed direction;
a cutter for cutting portions from a leading end of a food product fed towards the cutter by the feeder; and
a portion thickness control assembly comprising:
   a carriage carried by the machine base and able to move relative to the machine base in order to adjust the thickness of each portion to be cut from the food product;
   a carriage drive assembly coupled to the carriage to move the carriage relative to the machine base;
   a product stop carried by the carriage and able to move relative to the carriage between advanced and retracted positions; and
   a product stop drive assembly coupled to the product stop to move the product stop between the advanced and retracted positions,
such that, before the cutter starts to cut a next portion from the leading end of the food product, the carriage drive assembly is operable to move the carriage to a position relative to the machine base with reference to the thickness of the next portion to be cut, and the product stop drive assembly is operable to move the product stop from its retracted position to its advanced position for engagement by the leading end of the food product.

A1. A machine of paragraph A, wherein the carriage is able to move relative to the machine base in a direction parallel to the feed direction in order to adjust the thickness of each portion to be cut from the food product.

A2. A machine of paragraph A, wherein the product stop drive assembly includes a rotary actuator and a mechanical coupling arranged to couple the rotary actuator to the product stop so that the rotary actuator is operable to move the product stop between the advanced and retracted positions.

A2.1. A machine of paragraph A2, wherein the rotary actuator includes an axis of rotation and a driven mount which is spaced from its axis of rotation, the rotary actuator is operable to rotate the driven mount in an orbital motion around its axis of rotation, and the mechanical coupling is arranged to couple the driven mount of the rotary actuator to the product stop.

A3. A machine of paragraph A, wherein the product stop is mechanically coupled to the carriage by a pair of rigid arms, with a carriage end of each rigid arm being rotatably coupled to the carriage and a stop end of each rigid arm being rotatably coupled to the product stop, the carriage ends of the rigid arms are rotatable relative to the carriage about respective first and second pivotal axes, the stop ends of the rigid arms are rotatable relative to the product stop about respective third and fourth pivotal axes, the first to fourth pivotal axes are parallel to each other and perpendicular to the feed direction.

A3.1. A machine of paragraph A3, wherein the first and second pivotal axes are spaced apart along a direction which is non-parallel with the feed direction.

B. A method of operating a food portioning machine of any preceding claim, comprising the steps of:
a) moving the carriage relative to the support with the carriage drive assembly to adjust the thickness of a next portion to be cut from a food product;
b) moving the product stop to the advanced position with the product stop drive assembly; and
c) feeding the food product in the feed direction with the feeder until its leading end engages the product stop.

B1. A method of paragraph B, including the steps of:
d) after step c), starting to cut the next portion from the leading end of the food product; and
e) after step d), moving the product stop towards its retracted position with the product stop drive assembly before the next portion has been completely cut from the leading end of the food product.

1. A food portioning machine comprising:
a machine base;
a feeder for feeding a food product in a feed direction;
a cutter for cutting portions from a leading end of a food product fed towards the cutter by the feeder; and
a portion thickness control assembly comprising:
a carriage carried by the machine base and able to move relative to the machine base in order to adjust the thickness of each portion to be cut from the food product;
a carriage drive assembly coupled to the carriage to move the carriage relative to the machine base;
a product stop carried by the carriage and able to move relative to the carriage between advanced and retracted positions; and
a product stop drive assembly coupled to the product stop to move the product stop between the advanced and retracted positions,
such that, before the cutter starts to cut a next portion from the leading end of the food product, the carriage drive assembly is operable to move the carriage to a position relative to the machine base with reference to the thickness of the next portion to be cut, and the product stop drive assembly is operable to move the product stop from its retracted position to its advanced position for engagement by the leading end of the food product.

2. A machine of claim 1, wherein the carriage is able to move relative to the machine base in a direction parallel to the feed direction in order to adjust the thickness of each portion to be cut from the food product.

3. A machine of claim 1, wherein the product stop drive assembly includes a rotary actuator and a mechanical coupling arranged to couple the rotary actuator to the product stop so that the rotary actuator is operable to move the product stop between the advanced and retracted positions.

4. A machine of claim 3, wherein the rotary actuator includes an axis of rotation and a driven mount which is spaced from its axis of rotation, the rotary actuator is operable to rotate the driven mount in an orbital motion around its axis of rotation, and the mechanical coupling is arranged to couple the driven mount of the rotary actuator to the product stop.

5. A machine of claim 1, wherein the product stop is mechanically coupled to the carriage by a pair of rigid arms, with a carriage end of each rigid arm being rotatably coupled to the carriage and a stop end of each rigid arm being rotatably coupled to the product stop, the carriage ends of the rigid arms are rotatable relative to the carriage about respective first and second pivotal axes, the stop ends of the rigid arms are rotatable relative to the product stop about respective third and fourth pivotal axes, the first to fourth pivotal axes are parallel to each other and perpendicular to the feed direction.

6. A machine of claim 5, wherein the first and second pivotal axes are spaced apart along a direction which is non-parallel with the feed direction.

7. A method of operating a food portioning machine of claim 1, comprising the steps of:
a) moving the carriage relative to the support with the carriage drive assembly to adjust the thickness of a next portion to be cut from a food product;
b) moving the product stop to the advanced position with the product stop drive assembly; and
c) feeding the food product in the feed direction with the feeder until its leading end engages the product stop.

8. A method of claim 7, including the steps of:
d) after step c), starting to cut the next portion from the leading end of the food product; and
e) after step d), moving the product stop towards its retracted position with the product stop drive assembly before the next portion has been completely cut from the leading end of the food product.
